(19) United States
(12) Patent Application Publication
(10) Pub. No.: US 2019/0089544 A1
(43) Pub. Date: Mar. 21, 2019

(54) VALIDATION CODE ENCRYPTION MANAGER

(71) Applicant: International Business Machines Corporation, Armonk, NY (US)

(72) Inventors: JunXing Yang, SHENZHEN (CN); XueJun Zhong, SHENZHEN (CN)

(21) Appl. No.: 15/709,658

(22) Filed: Sep. 20, 2017

(51) Int. Cl. H04L 9/32; H04L 9/08; G06Q 20/38

(52) U.S. Cl. CPC H04L 9/3268; H04L 9/3226; H04L 9/0869; G06Q 2220/00; G06Q 20/38215; G06Q 20/385; H04L 9/3234

(57) ABSTRACT

An encryption manager generates an unencrypted validation code to authenticate a transaction associated with a user profile. The encryption manager generates an encrypted validation code based on the unencrypted validation code and an encryption policy associated with the user profile. The encryption manager sends the encrypted validation code to a user device associated with the user profile. The transaction is authenticated if a decrypted validation code generated based on user input matches the unencrypted validation code.

### BACKGROUND

The present disclosure relates to data encryption, and, more specifically, to encrypting short message service (SMS) validation codes.

### SUMMARY

Aspects of the present disclosure are directed toward a method comprising receiving, based on user input, a first encryption policy associated with a first user profile, the first encryption policy configured to encrypt a validation code by performing at least one of inserting at least one character in the validation code and performing at least one operation on at least one character of the validation code. The method can further comprise generating an unencrypted validation code in response to receiving an authentication request for the first user profile from a third party, where a successful authentication validates a transaction between the first user profile and the third party. The method can further comprise sending the unencrypted validation code to the third party and sending an encrypted validation code to a user device associated with the first user profile. The encrypted validation code can comprise the unencrypted validation code encrypted according to the first encryption policy. The transaction can be authenticated in response to the unencrypted validation code matching a decrypted validation code generated based on user input.

Further aspects of the present disclosure are directed toward a system comprising an encryption manager comprising a processor and a computer readable storage medium storing instructions which, when executed by the processor, cause the processor to perform a method comprising receiving, based on user input, a first encryption profile for a first user profile, the first encryption profile configured to encrypt a verification code by performing at least one of inserting at least one character in the verification code and performing at least one operation on at least one character of the verification code. The processor can perform a method further comprising generating an unencrypted verification code in response to receiving an authentication request for the first user profile from a third party, where a successful authentication validates a transaction between the first user profile and the third party. The processor can perform a method further comprising sending the unencrypted verification code the third party, generating an encrypted verification code comprising the unencrypted verification code encrypted according to the first encryption profile, and sending the encrypted verification code to a user device associated with the first user profile. The transaction can be authenticated in response to the unencrypted verification code matching a decrypted verification code generated based on user input.

Further aspects of the present disclosure are directed toward a computer program product comprising a computer readable storage medium storing instructions executable by a processor. The processor can be configured to execute the instructions to perform a method comprising storing, based on user input, a first encryption protocol configured to, for an authentication code, perform at least one of inserting at least one character into at least one position in the authentication code and performing at least one operation on at least one character in the authentication code. The processor can be configured to execute the instructions to perform a method further comprising, in response to identifying a transaction requiring authentication of a user by two-factor authentication, generating an unencrypted authentication code and an encrypted authentication code comprising the unencrypted authentication code encrypted according to the first encryption protocol, where the encrypted authentication code contains at least one different character compared to the unencrypted authentication code. The processor can be configured to execute the instructions to perform a method further comprising sending the encrypted authentication code to a user device and receiving, based on user input and in response to sending the encrypted authentication code on the user device, a decrypted authentication code. The processor can be configured to execute the instructions to perform a method further comprising, in response to the decrypted authentication code matching the unencrypted authentication code, completing the transaction.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates example short message service (SMS) validation codes, in accordance with some embodiments of the present disclosure.

FIG. 2 illustrates a block diagram of an example encryption manager functioning in a network, in accordance with some embodiments of the present disclosure.

FIG. 3 illustrates a flowchart of an example method for encrypting a validation code, in accordance with some embodiments of the present disclosure.

FIG. 4 illustrates a flowchart of an example method for decrypting a validation code, in accordance with some embodiments of the present disclosure.

FIG. 5A illustrates a flowchart of a first example method for encrypting a validation code, in accordance with some embodiments of the present disclosure.

FIG. 5B illustrates a flowchart of a second example method for encrypting a validation code, in accordance with some embodiments of the present disclosure.

FIG. 5C illustrates a flowchart of a third example method for encrypting a validation code, in accordance with some embodiments of the present disclosure.

FIG. 6 illustrates a block diagram of an encryption manager, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to data encryption, and, more specifically, to encrypting short message service (SMS) validation codes.

Aspects of the present disclosure are directed toward customized encryption of validation codes (e.g., SMS validation codes used in two-factor authentication protocols). Aspects of the present disclosure associate a customized encryption policy with a user profile. The customized encryption policy (also referred to as an encryption profile and/or an encryption protocol herein) can comprise adding one or more characters to one or more selected locations in a validation code (also referred to as a verification code and/or an authentication code herein), performing one or more operations on one or more selected characters in a validation code, or a combination of adding characters at selected locations and performing operations on selected characters in a validation code.

In some embodiments, an encryption manager (e.g., a telecommunications operator) can receive a request for a validation code to be sent to a user device, retrieve an encryption policy associated with the user device, encrypt the validation code according to the encryption policy, and send the encrypted validation code to the user device. In some embodiments, a user can receive an encrypted validation code on a first user device and input a decrypted validation code into the same or a different user device to complete an authentication operation.

Aspects of the present disclosure exhibit numerous advantages. First, aspects of the present disclosure encrypt a validation code sent to a user device, thereby protecting sensitive information in the event the validation code is compromised (e.g., if the user device is lost, stolen, or hacked).

Second, aspects of the present disclosure encrypt a validation code according to a user-defined, customized encryption policy. Thus, a compromised encryption policy can result in compromised security for a single user profile rather than compromised security for a group of user devices.

Third, aspects of the present disclosure are configured to notify an emergency contact and/or limit access in the event a validation code is incorrectly decrypted numerous times. Thus, aspects of the present disclosure can alert a user to suspicious behavior.

Fourth, aspects of the present disclosure exhibit strong encryption. For example, aspects of the present disclosure can encrypt a validation code having thousands, hundreds of thousands, millions, or more possible permutations.

Fifth, aspects of the present disclosure can accelerate encryption by adding and/or altering less than all of the characters in the validation code. Compared to conventional encryption, where every character may be altered, aspects of the present disclosure can encrypt a validation code more quickly (e.g., using less processing overhead, using less memory, etc.) than some conventional techniques.

The aforementioned advantages are example advantages, and embodiments exist which contain all, some, or none of the aforementioned advantages while remaining within the spirit and scope of the present disclosure.

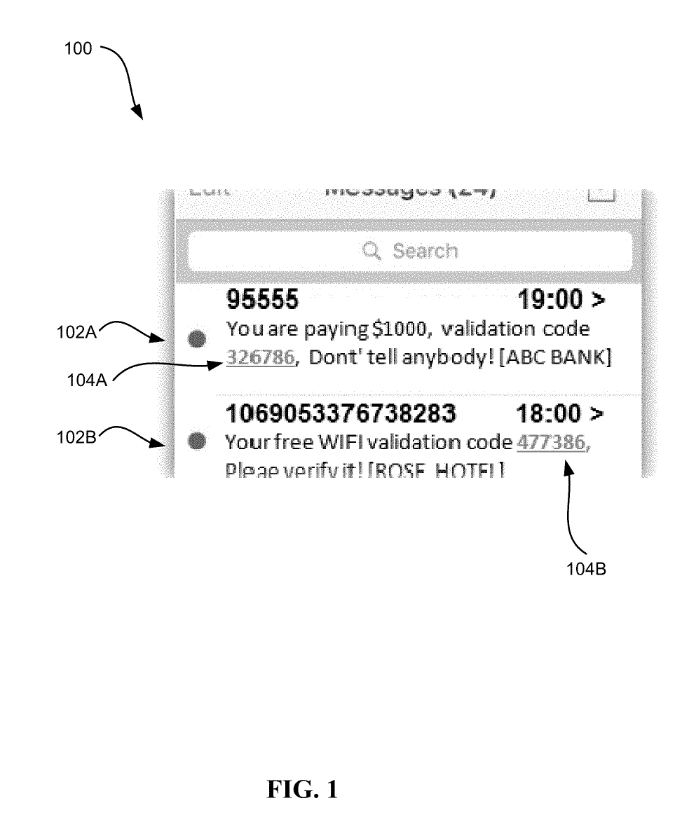

Referring now to the drawings, FIG. 1 illustrates an example short message service (SMS) validation code, in accordance with some embodiments of the present disclosure. A user interface 100 can display text messages such as a first text message 102A and a second text message 102B (e.g., SMS messages). First text message 102A can be associated with a first validation code 104A and second text message 102B can be associated with a second validation code 104B.

Aspects of the present disclosure encrypt validation codes by inserting one or more characters into the validation code and/or performing operations on one or more characters in the validation code. For example, first validation code 104A can be encrypted by adding a random number after the third number. Thus, encrypted first validation code 104A is “326786”. A user can decrypt the validation code by removing the third random number to determine the decrypted validation code is “32786”. In a second example, second validation code 104B can be encrypted by adding “2” to the second number. Thus, encrypted second validation code 104B is “477386”. A user can decrypt the second validation code 104B by subtracting “2” from the second number to determine the decrypted validation code is “475386”.

In various embodiments, different operations or combinations of operations can be performed on the validation code than described in the aforementioned examples. Furthermore, the validation codes can comprise more or fewer characters than shown in FIG. 1. Furthermore, although the validation codes shown in FIG.1 are numeric, the validation codes can include, individually or in combination, numbers, letters, symbols, and/or infographics. Thus, insertions into the validation code can include random or predetermined numbers, letters, symbols, and/or infographics. Likewise, operations performed on respective characters can relate to numbers, letters, symbols, and/or infographics.

For the purposes of the present disclosure, numbers can be, for example, digits, numerals, or other representations of quantity. Letters can be, for example, upper case and/or lower case letters of any language, and/or other letter-like symbols. Symbols can be, for example, punctuation, operators (e.g., “+”), indicators (e.g., a currency sign such as “$”), sentiment symbols (e.g., an emoticon), or other symbols. Infographics can be, for example, emojis, pictographs, or different infographics.

Where the operations are mathematical operations, and where the characters are not digits (e.g., letters), the mathematical operations may iterate through the sequence of characters according to the mathematical operation (e.g., iterating forward for addition and backward for subtraction).

As an example, a first character in a validation code can be the letter “A”. A mathematical operation can be “add 1 to the first character”. The output can transform “A” to “B” by iterating to the next character in the sequence (e.g., iterating +1 in the alphabet).

In instances where non-digit characters are not associated with a conventional sequence, the characters can be associated with a pre-determined sequence. For example, the symbol “!” could be associated with a first position in a sequence, and the symbol “@” can be associated with a second position in the sequence. Thus, for a validation code comprising “!” as the first character, and for a mathematical operation comprising “add 1 to the first character”, the encrypted first character can be transformed to “@” based on the “@” symbol being sequential (e.g., +1) to the “!” symbol according to the predetermined sequence.

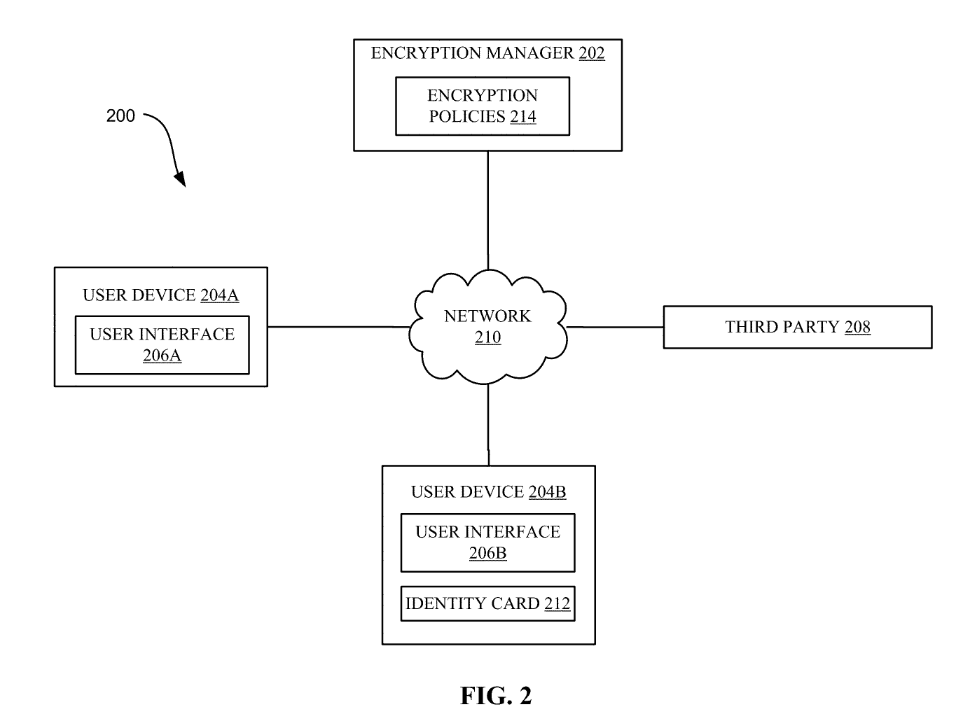

Referring now to FIG. 2, illustrated is an example validation code environment 200 including an encryption manager 202, a first user device 204A, a second user device 204B, and a third party 208 communicatively coupled by network 210. Network 210 can comprise a physical or virtual network. In some embodiments, network 210 is configured to communicate short message service (SMS) messages. In some embodiments, network 210 utilizes a Wi-Fi protocol. In some embodiments, network 210 utilizes a cellular protocol (e.g., 3G, 4G, etc.). In some embodiments, separate entities communicate with one another via separate networks and/or separate network protocols. For example, third party 208 can communicate with user device 204A via the Internet while encryption manager 202 can communicate with user device 204B via SMS messages.

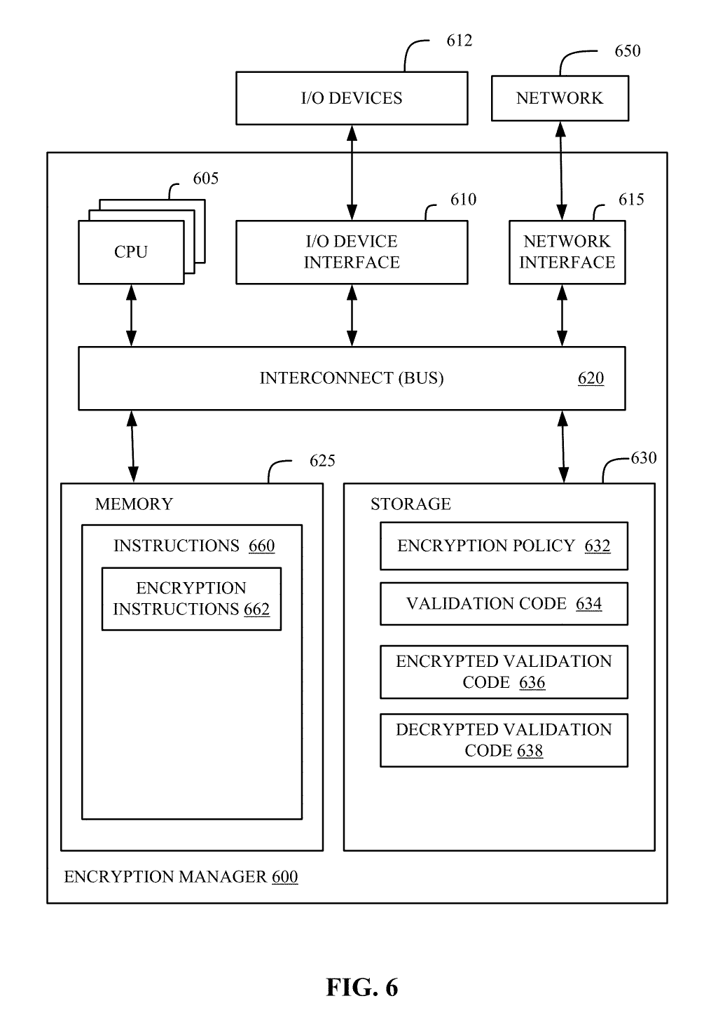

Encryption manager 202 can encrypt validation codes according to encryption policies 214 associated with user profiles of user devices (e.g., user device 204A and user device 204B). In some embodiments, encryption manager 202 is a communications service provider (CSP) such as a telecommunications operator. In some embodiments, encryption manager 202 is a standalone authentication service. Encryption manager 202 can store encryption policies 214 for respective user profiles. For example, encryption manager 202 can query an encryption policy database (not shown) interrelating encryption policies 214 with mobile telephone numbers and/or identity card (e.g., identity card 212) identification numbers (e.g., an integrated circuit card identifier (ICCID) associated with a subscriber identification module (SIM) card and/or an international mobile subscriber identity (IMSI) number associated with a SIM card). Encryption manager 202 is described in further detail hereinafter with respect to FIG. 6.

User device 204A and user device 204B (collectively referred to as a user device 204 herein) can be similar or different user devices such as a mobile phone, a laptop, a desktop, a tablet, or a different device capable of receiving a validation code and/or capable of initiating a transaction requiring authentication using a validation code. In some embodiments, at least one user device 204 is configured to initiate a transaction requiring authentication. In some embodiments, at least one user device 204 is configured for SMS communication. User device 204A includes user interface 206A and user device 204B likewise includes user interface 206B (hereinafter collectively referred to as user interface 206). User interface 206 can be configured to display an encrypted validation code to a user, receive input comprising a decrypted validation code, present an indication of successful authentication, and/or present an indication of unsuccessful authentication. At least one user device 204 includes an identity card 212 (e.g., as shown in user device 204B).

Identity card 212 can be, for example, a subscriber identification module (SIM) card. In various embodiments, the identity card 212 can comprise a full-size SIM, a mini-SIM, a nano-SIM, a Willcom-SIM (W-SIM), a universal SIM (USIM), a code-division multiple access (CDMA) SIM (CSIM), an embedded-SIM (eSIM), a virtual SIM, a removable user identity module (R-UIM), or a different device configured to identify a user profile and further configured to be associated with (e.g., communicatively coupled to, physically attachable to, virtually provisioned for, etc.) a user device.

Third party 208 can be an entity utilizing authentication such as two-factor authentication. Third party 208 can be, for example, a financial institution (e.g., a bank, a brokerage, etc.), a government institution, an educational institution, a business, and so on. Third party 208 can interface with a user device 204 by, for example, a website. Third party 208 can utilize validation codes to authenticate transactions associated with third party 208. Transactions can be, but are not limited to, financial transactions (e.g., a purchase, a loan application, a credit application, etc.), personal information changes (e.g., updating an address associated with a user profile, changing an election associated with a user profile), user profile creation (e.g., signing up for an online account, registering a device), authenticating an electronically signed document (e.g., a contract), and other transactions that may benefit from authentication.

As a first example, user device 204A can comprise a laptop. A user can access third party 208 via a login to a website associated with third party 208. A user may conduct a transaction over network 210 to third party 208. Third party 208 may wish to authenticate the transaction by two-factor authentication (e.g., a SMS validation code) before completing the transaction. Third party 208 can provide a SMS-capable mobile phone number associated with a user (e.g., retrieved from a user profile, or provided by the user) of user device 204A to encryption manager 202.

Encryption manager 202 can generate a validation code and provide the unencrypted validation code to third party 208 and an encrypted validation code to user device 204B. In some embodiments, the encryption manager 202 queries an encryption policy database to retrieve an appropriate encryption policy 214. The encrypted validation code provided to user device 204B can be encrypted according to a customized encryption policy 214 created by a user profile associated with user device 204B. In some embodiments, the customized encryption policy 214 is associated with an identity card 212 of user device 204B (which can also be associated with the mobile phone number provided to encryption manager 202 by third party 208). User device 204B can display the encrypted validation code on a user interface 206B. The user of both user device 204A and user device 204B can read the encrypted validation code presented on user interface 206B and input the decrypted validation code into the third party 208 website via user device 204A.

Third party 208 can determine if the unencrypted validation code received from encryption manager 202 matches the decrypted validation code received from user device 204A. In the event the validation codes match, the transaction can be authenticated and/or completed. In the event the validation codes do not match, the third party 208 can generate an error, request a new validation code be sent by encryption manager 202 to user device 204B, and/or cancel (e.g., terminate) the transaction. In some embodiments, after a threshold number of incorrect decrypted validation codes are input to user device 204A, an emergency contact associated with the user profile of user device 204A can be notified of suspicious behavior and/or access by user device 204A to third party 208 can be limited. For example, the notification can be textual (e.g., a text message, an email, etc.), verbal (e.g., a phone call, a voicemail, etc.), audible (e.g., an alarm such as beeping or ringing), and/or visual (e.g., a warning infographic such as a red exclamation point).

The previous example is for descriptive purposes and does not limit the disclosure. For example, instead of two user devices 204A and 204B, a single user device can be used where the single user device comprises, for example, a smartphone capable of both accessing a website of third party 208 and receiving SMS messages from encryption manager 202. Furthermore, although the validation code was generated by encryption manager 202, the validation code can likewise be generated by third party 208 and communicated to encryption manager 202 for encryption and sending to user device 204B. Furthermore, although third party 208 determined if the validation codes matched, encryption manager 202 can likewise determine if validation codes match. Furthermore, although encryption manager 202 is shown as a separate entity, encryption manager 202 can also reside within user device 204B, or, in some embodiments, encryption manager can be a service provided by third party 208.

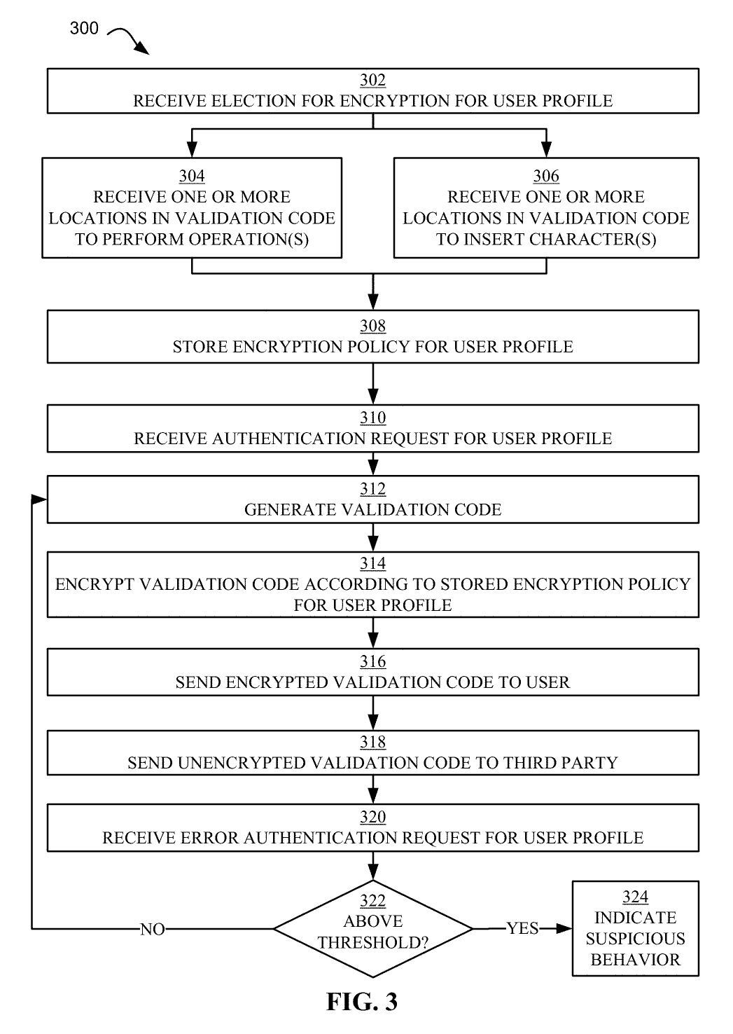

Referring now to FIG. 3, illustrated is a flowchart of an example method 300 for encrypting a validation code, in accordance with some embodiments of the present disclosure. The method 300 can be performed by an encryption manager (e.g., encryption manager 202 of FIG. 2) or by a processor executing instructions. For clarity, the method 300 will hereafter be described as being performed by an encryption manager, but in various embodiments the method 300 can be performed by alternative configurations of hardware.

In operation 302, the encryption manager can receive an election for encrypted validation codes for a particular user profile. In some embodiments, the user profile is associated with a particular subscriber identification module (SIM) card. Operations 302-306 can be received by the encryption manager via a user interface communicatively coupled to the encryption manager (e.g., by a user interface of a user device connected to the encryption manager via a network). For example, operations 302-306 can be performed when a SIM card is configured for a particular user.

In operation 304, the encryption manager can receive one or more locations in a validation code to perform one or more operations (e.g., mathematical operations). Thus, operation 304 can comprise a location indication (e.g., the fourth digit), a mathematical operation (e.g., plus, minus, multiply, divide), and a value associated with the operation (e.g., 2) to indicate an encryption rule such as “add 2 to the fourth digit of the validation code”. In some embodiments, multiple operations can be performed on a single character. In some embodiments, different operations (or combinations of operations) can be performed on different characters (e.g., add 2 to the second digit and subtract 1 from the fourth digit). In some embodiments, the operations can cause the respective character to become impractical (e.g., adding “2” to a third digit comprising “9” equals “11”, but only one digit is allowed for the third digit). In such instances, various rules can be used to reduce the impractical number to a usable number. For example, a rightmost number can be used in mathematical operations resulting in values larger than nine (e.g., a sum “12” can be displayed as “2”).

In operation 306, the encryption manager receives one or more locations in the validation code to add a character. The one or more locations can comprise before or after a respective digit. The added characters can be a random character (e.g., a random number) or a predetermined character.

In accordance with various embodiments, one or both of operations 304 and 306 are performed. For example, in some embodiments, the encryption policy comprises insertion of characters. In other embodiments, the encryption policy comprises performing operations on one or more characters. In other embodiments, the encryption policy comprises both inserting characters and performing operations on one or more characters. In embodiments including both operations 304 and 306, the operations can be performed approximately simultaneously and then combined, or the operations can be performed sequentially. When the operations are performed sequentially, the operations can be performed in either order. However, in some embodiments, operation 306 will be performed prior to operation 304 so that operations will be performed on characters in the unencrypted validation code rather than possible inserted characters. For example, for an encryption policy configured to insert a random number after the first character and add 1 to the second character, an encryption policy can encrypt a validation code by performing the operation on the second character first and then inserting the random number. If done in reverse (e.g., inserting the random number and then performing the operation), the operation would be performed on the inserted, random number.

In operation 308, the encryption manager stores the encryption policy for the user profile. The encryption policy can be associated with the user profile by, for example, a mobile phone number or an identifier associated with a SIM card. When associated with a SIM card, the encryption policy can be associated with, for example, a unique serial number (e.g., an integrated circuit card identifier (ICCID) and/or an international mobile subscriber identity (IMSI) number) associated with the SIM card.

In some embodiments, an ICCID associated with the SIM card comprises less than or equal to 22 digits. In some embodiments, the ICCID associated with the SIM card comprises 20 digits. In some embodiments, the ICCID associated with the SIM card comprises an issuer identification number (IIN), an individual account identifier, and a check digit. In some embodiments, the check digit is calculated from one or more other digits in the ICCID using an algorithm such as, for example, the Luhn algorithm.

In some embodiments, an IMSI number comprises three digits indicating a mobile country code (MCC), two digits or three digits indicating a mobile network code (MNC), and 15 or fewer digits indicating a mobile subscriber identification number (MSIN).

In operation 310, the encryption manager can receive an authentication request related to the user profile (e.g., a request for SMS authentication and a mobile phone number). In some embodiments, the encryption manager receives the authentication request from a third party. In some embodiments, the authentication request can include a mobile phone number associated with a user profile for which the encryption manager stores an encryption policy.

In operation 312, the encryption manager can generate a validation code. The generated validation code can be, for example, numeric or alphanumeric. The generated validation code can include, but is not limited to, numbers, letters, symbols, and/or infographics. In alternative embodiments, the encryption manager can receive a pre-generated validation code together with the request in operation 310 (e.g., the validation code can be generated at a third party and provided to the encryption manager in operation 310).

In operation 314, the encryption manager can encrypt the validation code according to the stored encryption policy associated with the user profile. Encrypting the validation code can include inserting one or more characters in one or more selected positions in the validation code, performing one or more operations on one or more characters in the validation code, or inserting one or more characters in one or more selected positions in the validation code and performing one or more operations on one or more characters in the validation code.

In operation 316, the encryption manager can send the encrypted validation code to a user device associated with the user profile. For example, the encryption manager can send the encrypted validation code by SMS message to a mobile phone number associated with the user profile.

In operation 318, the encryption manager can send the unencrypted validation code to the third party that sent the authentication request to the encryption manager.

In operation 320, the encryption manager can receive an indication of authentication failure from the third party. The authentication failure can indicate that the third party received the unencrypted validation code from the encryption manager and a decrypted validation code from a user device associated with the user and determined that the unencrypted validation code does not match the decrypted validation code (e.g., at least one character can be different between the unencrypted validation code and the decrypted validation code). In response to the third party indicating authentication failure, the encryption manager can determine if a number of failed attempts (e.g., incorrectly decrypted validation codes provided by the user to the third party) is above a threshold (e.g., greater than or equal to three) in operation 322.

If the number of failed attempts is below the threshold, the encryption manager can return to operation 312 and generate a new validation code. If the number of failed attempts is above the threshold, the encryption manager can proceed to operation 324 and provide an indication of suspicious behavior. The encryption manager can indicate suspicious behavior by, for example, refusing to generate additional validation codes for the third party, sending a notification (e.g., a text message, a voice message, an email, etc.) to a user device associated with the user profile (e.g., an email address, an emergency contact phone number, etc.), by sending a warning to the user device, and/or by limiting functionality of the user device (e.g., by locking the user device, by turning the user device off, etc.).

Although not shown in FIG. 3, in some embodiments, encryption manager 202 described in FIG. 2 can receive an indication that authentication was successful. Likewise, although not shown, in some embodiments, encryption manager 202 can receive the decrypted validation code, compare it to the unencrypted validation code, determine if the authentication is successful, transmit the indication of success or failure to the user device and/or a third party, and/or complete (or cancel) the transaction.

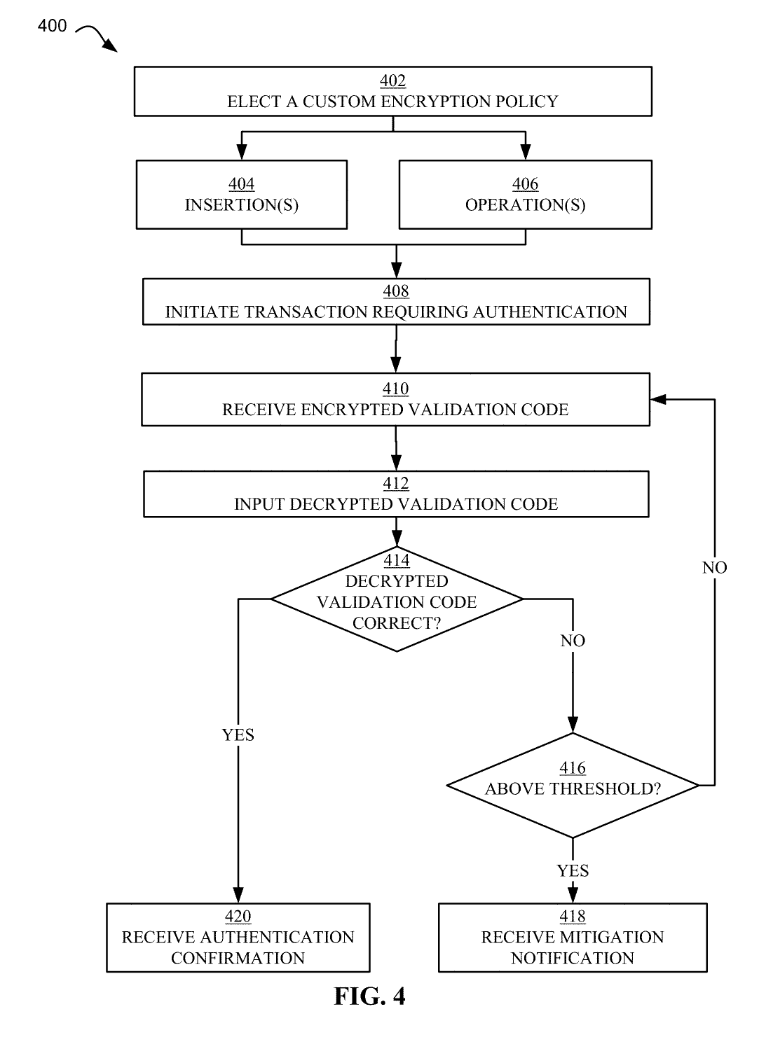

FIG. 4 illustrates a flowchart of an example method 400 for decrypting an encrypted validation code, in accordance with some embodiments of the present disclosure. The method 400 can be performed by one or more user devices (e.g., user device 204A and/or user device 204B of FIG. 2) interacting with a user or by a processor executing instructions and receiving inputs from a user. For clarity, the method 400 will hereafter be described as being performed by a user device, but in various embodiments the method 400 can be performed by alternative configurations of hardware.

In operation 402, a user device can be associated with an encryption policy based on input to the user device. A custom encryption policy can be assigned at time of purchase of, configuration of, or during use of, the user device. For example, if the user device is a mobile phone associated with a SIM card, the user device can be assigned a custom encryption policy when the mobile phone and/or SIM card are purchased, when the mobile phone and/or SIM card are configured, or at a later time. In some embodiments, a user device is assigned a custom encryption policy based on user input to a website associated with a telecommunications operator configured to interact with a user's mobile phone and/or SIM card.

In operation 404, the user device can define (e.g., based on user input) a custom encryption policy having one or more insertions. The one or more insertions can be based on user input that identifies a location of an insertion (e.g., before the fourth digit, after the first character, etc.) and a type of insertion (e.g., a random number, a pre-determined number, a random character, a pre-determined character, etc.) for each insertion.

In operation 406, the user device can define (e.g., based on user input) a custom encryption policy comprising one or more operations. The one or more operations can comprise mathematical operations (e.g., addition, subtraction, multiplication, division, etc.). The one or more operations can be based on input selecting a character (e.g., the fourth digit), selecting an operation (e.g., addition) and selecting a value for the operation (e.g., two). Thus, an example operation could be “add two to the fourth digit of a validation code”.

Although operations 404 and 406 are shown separately, they can occur simultaneously or sequentially. In some embodiments, one of operations 404 and 406 occur, whereas in other embodiments both operations 404 and 406 occur.

In operation 408, the user device can initiate a transaction requiring authentication. For example, the user device can initiate a transaction requiring authentication by interacting with a website of a third party. The transaction can be, for example, a financial transaction, an information change, a profile creation, a contract signing, and so on.

In operation 410, the user device can receive an encrypted validation code and display the encrypted validation code on a user interface of the user device. In some embodiments, the encrypted validation code is received in a SMS text message. The encrypted validation code can be encrypted according to the encryption policy defined in operations 402-406.

In operation 412, the user device can input the decrypted validation code to the third party. The user device can receive the decrypted validation code from user input to a user interface (e.g., touchscreen, keypad, etc.) of the user device. In some embodiments, operation 412 is performed by a different user device than the user device receiving the encrypted validation code in operation 410.

In operation 414, the user device receives an indication if the decrypted validation code was successful. If the decrypted validation code was successful, the user device can present an indication that the authentication operation was successful in operation 420.

If the decrypted validation code was incorrect in operation 414, and the number of authentication attempts are determined to be below a threshold (e.g., three) in operation 416, the user device can present a new encrypted validation code in operation 410 and proceed again through the remainder of the method 400.

If the number of authentication attempts is above the threshold in operation 416, then the user device presents a mitigation notification in operation 418. For example, the mitigation notification can indicate that the authentication operation was unsuccessful, that the authentication operation was terminated, that another user device associated with the user profile has been notified of suspicious activity, that the user device has been logged off the third party website, and so on.

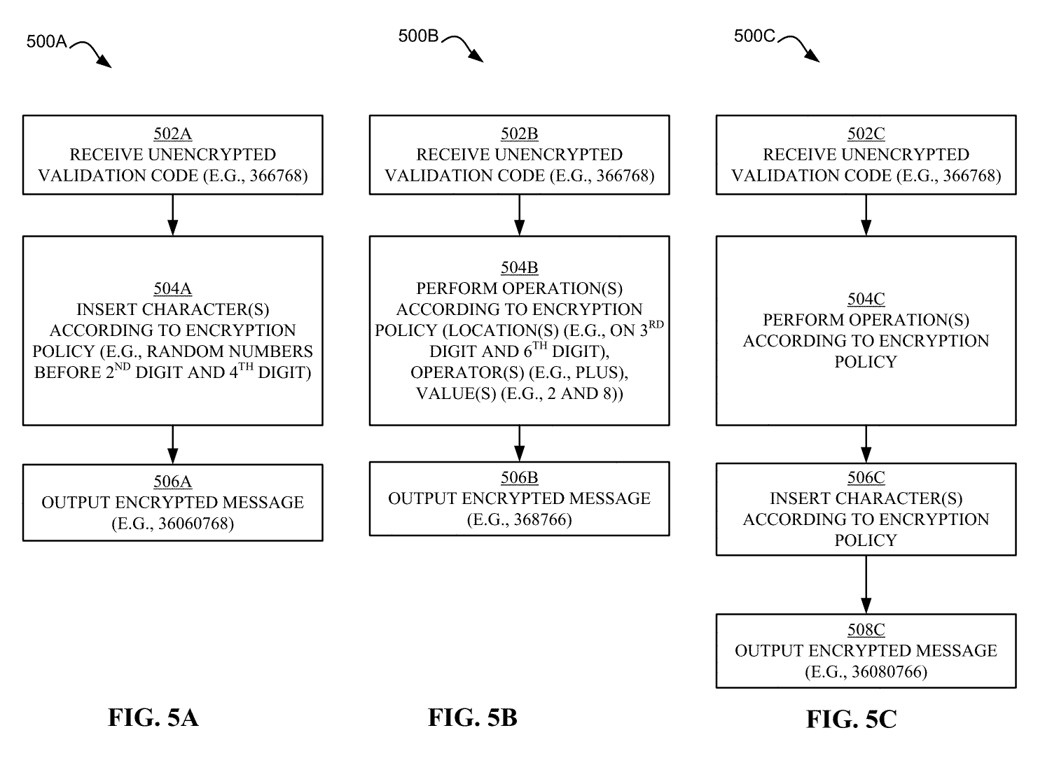

FIGS. 5A-5C illustrate example encryption policies in accordance with various embodiments of the present disclosure. In various embodiments, the methods 500A-500C are sub-methods of operation 314 of FIG. 3. The methods 500A-500C can be performed by, for example, an encryption manager (e.g., encryption manager 202 of FIG. 2) or by a processor executing instructions. For clarity, the methods 500A-500C will hereafter be described as being performed by an encryption manager, but in various embodiments the methods 500A-500C can be performed by alternative configurations of hardware.

FIG. 5A illustrates a first example encryption policy 500A, in accordance with some embodiments of the present disclosure. In operation 502A, the encryption manager receives (or generates) an unencrypted validation code such as, for example, the code “366768”. In operation 504A, the encryption manager inserts one or more character(s) at predetermined location(s) in the validation code generated in operation 502A. For example, a random number could be inserted before the second digit and before the fourth digit of the validation code. In operation 506A, the encryption manager can output the encrypted validation code. For example, the validation code “366768” could be encrypted to “36060768”. However, the validation code could likewise be encrypted with alternative random numbers (e.g., 36165768). Although only one random number was inserted at each predetermined location, more than one random number could likewise be inserted (e.g., two random numbers after the third digit).

FIG. 5B illustrates a second example encryption policy 500B, in accordance with some embodiments of the present disclosure. In operation 502B, the encryption manager receives (or generates) an unencrypted validation code such as, for example, the code “366768”. In operation 504B, the encryption manager performs at least one operation according to an encryption policy. For example, the encryption policy could indicate that two should be added to the third digit and that eight should be added to the sixth digit. In operation 506B, the encryption manager can output the encrypted validation code. For example, the encrypted validation code could be “368766”. The encryption policy can contain additional information regarding impractical numbers such as, but not limited to, double digit numbers. For example, eight added to the third digit (8) results in 16. However, in this example, only digits 0 through 9 are allowed for respective digits in the validation code. In this example, the rightmost digit (i.e., 6) was preserved as the encrypted digit. In alternative embodiments, the result (16) could be manipulated in a different way sufficient to reduce the result to a single digit while providing sufficient information to a user to be able to decrypt the encrypted validation code.

FIG. 5C illustrates a third example encryption policy 500C, in accordance with some embodiments of the present disclosure. In operation 502C, the encryption manager receives (or generates) an unencrypted validation code such as, for example, the code “366768”. In operation 504C, the encryption manager performs operation(s) in accordance with the encryption policy (e.g., the mathematical operations described in operation 504B of FIG. 5B). In operation 506C, the encryption manager inserts character(s) into the validation code in accordance with the encryption policy (e.g., the random number insertion points described in operation 504A of FIG. 5A). In operation 508C, the encryption manager can output the encrypted validation code. For example, the encrypted validation code can be “36080766”.

FIG. 6 illustrates a block diagram of an encryption manager 600, in accordance with some embodiments of the present disclosure. In some embodiments, encryption manager 600 is consistent with encryption manager 202 of FIG. 2. In various embodiments, encryption manager 600 can perform, or provide executable instructions for the performance of, the methods described in FIGS. 3-5.

The encryption manager 600 can include a memory 625, storage 630, an interconnect (e.g., BUS) 620, one or more CPUs 605 (also referred to as processors 605 herein), an I/O device interface 610, I/O devices 612, and a network interface 615.

Each CPU 605 retrieves and executes programming instructions stored in the memory 625 or storage 630. The interconnect 620 is used to move data, such as programming instructions, between the CPUs 605, I/O device interface 610, storage 630, network interface 615, and memory 625. The interconnect 620 can be implemented using one or more busses. The CPUs 605 can be a single CPU, multiple CPUs, or a single CPU having multiple processing cores in various embodiments. In some embodiments, a CPU 605 can be a digital signal processor (DSP). Memory 625 is generally included to be representative of a random access memory (e.g., static random access memory (SRAM), dynamic random access memory (DRAM), or Flash).

The storage 630 is generally included to be representative of a non-volatile memory, such as a hard disk drive, solid state device (SSD), removable memory cards, optical storage, or flash memory devices. In an alternative embodiment, the storage 630 can be replaced by storage area-network (SAN) devices, the cloud, or other devices connected to the encryption manager 600 via the I/O devices interface 610 or a network 650 via the network interface 615.

In some embodiments, the memory 625 stores instructions 660 and the storage 630 stores encryption policy 632, validation code 634, encrypted validation code 636, and decrypted validation code 638. However, in various embodiments, the instructions 660, encryption policy 632, validation code 634, encrypted validation code 636, and decrypted validation code 638 are stored partially in memory 625 and partially in storage 630, or they are stored entirely in memory 625 or entirely in storage 630, or they are accessed over a network 650 via the network interface 615.

The encryption policy 632 can comprise instructions for encrypting a validation code according to a predetermined encryption policy defined by a user comprising one or more inserted characters and/or one or more operations on one or more characters.

Validation code 634 can comprise a code received by (or generated by) the encryption manager 600 and used to authenticate a user. Validation code 634 can comprise numbers (e.g., digits), letters, symbols, and/or infographics.

Encrypted validation code 636 can comprise the validation code 634 encrypted according to the encryption policy 632.

Decrypted validation code 638 can comprise the validation code received in response to sending the encrypted validation code 636. The decrypted validation code 638 should match the validation code 634 in order to authenticate a user. The decrypted validation code 638 can be generated based on user input.

The instructions 660 are processor executable instructions including encryption instructions 662. Encryption instructions 662 can include instructions to execute the methods shown in FIGS. 3-5.

In various embodiments, the I/O devices 612 can include an interface capable of presenting information and receiving input. For example, I/O devices 612 can present information to a user interacting with encryption manager 600 and receive input from a user.

Encryption manager 600 is connected to the network 650 via the network interface 615. In some embodiments, network 650 is consistent with network 210 of FIG. 2.

Embodiments of the present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or subset of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any of the instructions stored in instructions 660 of FIG. 6 and/or any software configured to perform any subset of the methods described with respect to FIGS. 3-5) may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing, or otherwise receiving payment for use of the systems.

What is claimed is:

1. A method comprising:
receiving, based on user input, a first encryption policy associated with a first user profile, the first encryption policy configured to encrypt a validation code by performing at least one of:
inserting at least one character in the validation code; and
performing at least one operation on at least one character of the validation code;
generating an unencrypted validation code in response to receiving an authentication request for the first user profile from a third party, wherein a successful authentication validates a transaction between the first user profile and the third party;
sending the unencrypted validation code to the third party;
sending an encrypted validation code to a user device associated with the first user profile, wherein the encrypted validation code comprises the unencrypted validation code encrypted according to the first encryption policy; and
wherein the transaction is authenticated in response to the unencrypted validation code matching a decrypted validation code generated based on user input.

2. The method according to claim 1, wherein the first encryption policy comprises inserting at least one digit into at least one position in the validation code, wherein the at least one position is based on user input, and wherein the at least one digit comprises a random number.

3. The method according to claim 1, wherein the first encryption policy comprises performing a mathematical operation on at least one character in the validation code, wherein the mathematical operation comprises a respective character of the validation code, a mathematical operator, and a value.

4. The method according to claim 1, wherein the first encryption policy encrypts a validation code by performing at least one mathematical operation on at least one character of the validation code and by inserting at least one random character in at least one location in the validation code.

5. The method according to claim 4, wherein the at least one mathematical operation comprises addition, wherein a predetermined value is added to a designated character of the validation code, wherein the predetermined value and the designated character are based on user input.

6. The method according to claim 5, wherein a rightmost digit is displayed in the encrypted validation code for a sum exceeding nine and resulting from the at least one mathematical operation.

7. The method according to claim 1, further comprising:
in response to receiving a second authentication request for the first user profile from the third party, generating a second unencrypted validation code;
sending the second unencrypted validation code to the third party;
sending a second encrypted validation code to the user device, wherein the second encrypted validation code comprises the second unencrypted validation code encrypted according to the first encryption policy; and
in response to at least one character in the second unencrypted validation code being different from at least one character in a second decrypted validation code generated based on user input, sending a notification to a second user device indicating suspicious activity on the user device.

8. The method according to claim 1, wherein the user device is associated with a subscriber identification module (SIM) card, and wherein the encrypted validation code comprises a short message service (SMS) message.

9. A system comprising:
an encryption manager comprising a processor and a computer readable storage medium storing instructions which, when executed by the processor, cause the processor to perform a method comprising:
receiving, based on user input, a first encryption profile for a first user profile, the first encryption profile configured to encrypt a verification code by performing at least one of:
inserting at least one character in the verification code; and
performing at least one operation on at least one character of the verification code;
generating an unencrypted verification code in response to receiving an authentication request for the first user profile from a third party, wherein a successful authentication validates a transaction between the first user profile and the third party;
sending the unencrypted verification code to the third party;
generating an encrypted verification code comprising the unencrypted verification code encrypted according to the first encryption profile;
sending the encrypted verification code to a user device associated with the first user profile; and
wherein the transaction is authenticated in response to the unencrypted verification code matching a decrypted verification code generated based on user input.

10. The system according to claim 9, wherein the encrypted verification code is sent to the user device in a short message service (SMS) format.

11. The system according to claim 9, wherein the first encryption profile and the first user profile are associated with a subscriber identification module (SIM) card of the user device.

12. The system according to claim 9, wherein the first encryption profile comprises inserting at least one character into at least one position in the verification code, wherein the at least one position is based on user input, and wherein the at least one character comprises a random letter.

13. The system according to claim 9, wherein the first encryption profile comprises adding a user-defined value to a respective character in the verification code.

14. The system according to claim 13, wherein the respective character comprises a letter, wherein the letter is associated with a sequence of letters, wherein adding the user-defined value to the respective character comprises iterating through the sequence of letters by the user-defined value.

15. A computer program product comprising a computer readable storage medium storing instructions executable by a processor, wherein the computer readable storage medium is not a transitory signal per se, wherein the processor is configured to execute the instructions to perform a method comprising:
storing, based on user input, a first encryption protocol configured to, for an authentication code, perform at least one of:
inserting at least one character into at least one position in the authentication code; and
performing at least one operation on at least one character in the authentication code;
in response to identifying a transaction requiring authentication of a user by two-factor authentication, generating an unencrypted authentication code and an encrypted authentication code comprising the unencrypted authentication code encrypted according to the first encryption protocol, wherein the encrypted authentication code contains at least one different character compared to the unencrypted authentication code;
sending the encrypted authentication code to a user device;
receiving, based on user input and in response to sending the encrypted authentication code on the user device, a decrypted authentication code; and
in response to the decrypted authentication code matching the unencrypted authentication code, completing the transaction.

16. The computer program product according to claim 15, wherein the first encryption protocol comprises inserting at least one character into at least one position in the authentication code, wherein the at least one position is based on user input, and wherein the at least one character comprises a predetermined character.

17. The computer program product according to claim 16, wherein the first encryption protocol further comprises performing at least one mathematical operation on at least one character in the authentication code, wherein the at least one mathematical operation comprises: a predetermined character of the unencrypted authentication code, a mathematical operator, and a value, wherein the value is combined with the predetermined character according to the mathematical operator.

18. The computer program product according to claim 15, wherein the encrypted authentication code is sent to the user device in short message service (SMS) format, and wherein the user device comprises a subscriber identification module (SIM) card, wherein an integrated circuit card identifier (ICCID) number of the SIM card is associated with the first encryption protocol.

19. The computer program product according to claim 15, the instructions further configured to cause the processor to perform a method further comprising:
in response to the decrypted authentication code differing from the unencrypted authentication code by at least one character, sending a second encrypted authentication code to the user device, wherein the second encrypted authentication code is encrypted according to the first encryption protocol, wherein the second encrypted authentication code contains at least one different character compared to a second unencrypted authentication code, wherein the second unencrypted authentication code is different from the unencrypted authentication code;
receiving, based on user input and in response to sending the second encrypted authentication code on the user device, a second decrypted authentication code; and
in response to the second decrypted authentication code differing from the second unencrypted authentication code by at least one character, terminating the transaction.

20. The computer program product according to claim 19, the instructions further configured to cause the processor to perform a method comprising:
in response to the second decrypted authentication code differing from the second unencrypted authentication code by at least one character, sending a notification to different user device associated with the first encryption protocol.
